(19) United States
(12) Patent Application Publication
(10) Pub. No.: US 2013/0024299 A1
(43) Pub. Date: Jan. 24, 2013

(54) Mobile Based Voiceless Drive Through Ordering System and Method

(71) Applicants: Thomas Wong, Skokie, IL (US); Tao Shen, Chicago, IL (US)

(72) Inventors: Thomas Wong, Skokie, IL (US); Tao Shen, Chicago, IL (US)

(21) Appl. No.: 13/547,578

(22) Filed: Jul. 12, 2012

Related U.S. Application Data
(60) Provisional application No. 61/509,248, filed on Jul. 19, 2011.

(51) Int. Cl. G06Q 50/12; G06Q 30/06

(52) U.S. Cl. 705/15; 705/27.1

(57) ABSTRACT

A mobile-based voiceless drive-through ordering system and method in a downloadable mobile application, used in conjunction with a wireless network of a restaurant, Bluetooth wireless personal area network at the drive-through of a restaurant, and a back-end data server at the restaurant. The user opens the downloaded mobile-based application and, when in range of the restaurant's WiFi, makes an order from the restaurant menu, which is displayed on the mobile device. As the user approaches the drive-through kiosk of the restaurant, the mobile device detects the signal from the Bluetooth transmitter in the drive-through kiosk and allows the user to submit the order through the mobile-based application. The order is transmitted through the restaurant's wireless network to the restaurant's back-end server and is immediately available for kitchen and cashier processing. Further embodiments allow for ordering from a remote location and producing a QR code representing the order number.

This application claims priority of U.S. Provisional Application Ser. No. 61/509248 filed Jul. 19, 2011.

### BACKGROUND OF THE INVENTION

1. Field of the Invention

The present invention relates to a mobile application for retail service, and more particularly to a mobile-based voiceless drive-through ordering system.

2. Description of the Prior Art

The conventional drive-through system is based on two-way voice communication, where the order is taken through a server/customer dialog. The two-way voice dialog results in unavoidable miscommunication, through human error or equipment malfunction, which may significantly reduce the speed of service and customer satisfaction. The present invention, a mobile-based voiceless drive-through ordering system, aims to overcome these obstacles by utilizing wireless technology employed in most common mobile device platforms.

U.S. Pat. Nos. 6,384,850 and 6,982,733 both disclose an information management and synchronous communications system with menu generation. Patent '733 also discloses handwriting and voice modification of orders. The system and method of patents '850 and '733 facilitates database equilibrium and synchronization with wired, wireless and web-based systems, user-friendly and efficient generation of computerized menus and reservations for restaurants and other applications that utilize equipment with nonstandard graphical formats, display sizes and/or applications for use in remote data entry, information management and communication with host computer, digital input device or remote pager via standard hardwired connection, the internet, a wireless link or the like. While patents '850 and '733 disclose the use of handheld devices for menu ordering or making a reservation, the handheld devices are given to servers and employees of the restaurant in order to take customer orders. The handheld devices are not used by customers and they are not used for drive-through ordering. Furthermore, patents '850 and '733 do not disclose a mobile device that is used for drive-through ordering when in proximity to a drive-through kiosk equipped with a proximity sensor.

U.S. patent application publication 2010/0262554 discloses an in-store wireless shopping network using hand-held devices. The system of publication '554 includes a display, a communication circuit, a memory storing a shopping program, and a processor in communication with the display, the communication circuit and the memory. The processor is configured to execute the shopping program to access a product database including product information, to process inputs supplied to the system to generate a shopping list comprising one or more products from the product database and to provide guidance information on the display relating to product location in a store of the products on the shopping list. Patent publication '554 does not disclose a mobile device that is used for drive-through ordering when in proximity to a drive-through kiosk equipped with a proximity sensor.

GrubHub.com and Snapfinger.com both provide a website and a mobile application for online food ordering. The user goes to the website or opens the mobile application and enters their location and the restaurant or cuisine that they are looking for. The application searches within those parameters and comes up with local establishments. The user picks a restaurant and can place an order online or via the mobile application. The user can also pay for the order online or via the mobile application using a credit or debit card. The user can either pick up their order when ready or have it delivered. These two mobile applications do not disclose a system and method for drive-through ordering when in proximity to a drive-through kiosk equipped with a proximity sensor.

Starbucks offers a mobile application that provides an easy way to pay. The mobile application allows the user to use their mobile phone to display a barcode, associated with their Starbucks Card, which is used to make purchases at Starbucks. The application also allows the user to check their balance, reload their Starbucks Card with any major credit card, view their transactions, and track their Stars in the My Starbucks Rewards program. The mobile application does not disclose a mobile application that is used for drive-through ordering when in proximity to a drive-through kiosk equipped with a proximity sensor.

The prior art to date does not disclose a mobile-based voiceless drive-through ordering system for use when in proximity to a drive-through kiosk equipped with a proximity sensor. None of the prior art can be combined in this way to suggest these necessary modifications. There is no teaching, suggestion, or motivation that would have enabled a person of ordinary skill in the art to modify any prior art ordering application to allow for drive-through ordering when in proximity to a drive-through kiosk to enhance the quality and efficiency of drive-through service.

It is a primary object of the present disclosure to provide a mobile-based voiceless drive-through ordering system and method that reduces miscommunication and significantly increases the speed of service and customer satisfaction by immediately transmitting the pre-generated order information.

It is another object of the present disclosure to provide a mobile-based voiceless drive-through ordering system and method that provides for in-application payment options to further increase the order completion rate by minimizing the time of the transaction taking place at the drive-through window.

It is yet another object of the present disclosure to provide a mobile-based voiceless drive-through ordering system and method that enhances quality, efficiency and customers' satisfaction by providing menu information in advance, allowing the customer to make an order without any time pressure, and removing a degree of human error in the order-taking process to minimize the possibility of wrong order delivering to the customer.

It is yet another object of the present disclosure to provide a mobile-based voiceless drive-through ordering system and method that is of low cost of installation and maintenance, requiring mainly software integration and very few hardware upgrades for both the user and restaurant.

It is yet another object of the present disclosure to provide a mobile-based voiceless drive-through ordering system and method that is custom configurable and adaptable to other transactions, where the system can be further modified to support multi-line, multi-window configurations according to specific needs by setting up multiple synchronization points and product delivery windows. The system is also adaptable to other kinds of drive-through services, such as pharmacy and banking.

### SUMMARY OF THE INVENTION

The mobile-based voiceless drive-through ordering method and system of an illustrated embodiment of the present invention comprises a downloadable mobile application, a wireless network, Bluetooth wireless personal area network at the drive-through of a restaurant, and a back-end data server at the restaurant. The user opens the downloaded mobile-based application and, when in range of the restaurant's WiFi, makes an order from the restaurant menu, which is displayed on the mobile device. As the user approaches the drive-through kiosk of the restaurant, the mobile device detects the signal from the Bluetooth transmitter in the drive-through kiosk and allows the user to submit the order through the mobile-based application. The order is transmitted through the restaurant's wireless network to the restaurant's back-end server and is immediately available for kitchen and cashier processing. The user can then pick up the completed order at the drive-through window.

In a further embodiment, the user can place an order from a remote location. The user chooses a restaurant and transmits the order information and an estimated time of arrival from the remote location. The order is held until the user arrives at the restaurant and the mobile device detects the signal from the Bluetooth in the drive-through kiosk, at which time the order is sent to the kitchen and cashier for processing. The user can then pick up his completed order at the drive-through window.

In yet another embodiment, the user's order and payment information is stored in a QR code and transmitted to the restaurant's back-end server. Upon arrival, the user places the QR code that's in the mobile-based application to the camera at the restaurant's drive-through kiosk. The order is sent to the kitchen and cashier for processing and the user can pick up his completed order at the drive-through window.

### BRIEF DESCRIPTION OF THE DRAWINGS

The systems, methods, and computer readable media for controlling display objects in accordance with this specification are further described with reference to the accompanying drawings in which:

FIG. 1 depicts a flow diagram of the system architecture of an illustrated embodiment of the system and method of the present invention.

FIG. 2 depicts a system implementation in a typical one-lane drive through facility of an illustrated embodiment of the system and method of the present invention.

FIG. 3 depicts a user interface of an illustrated embodiment of the system and method of the present invention.

FIG. 4 depicts a flow diagram of a first embodiment of the system and method of the present invention.

FIG. 5 depicts a flow diagram of a second embodiment of the system and method of the present invention.

FIG. 6 depicts a flow diagram of a third embodiment of the system and method of the present invention.

### DETAILED DESCRIPTION OF THE ILLUSTRATED EMBODIMENTS

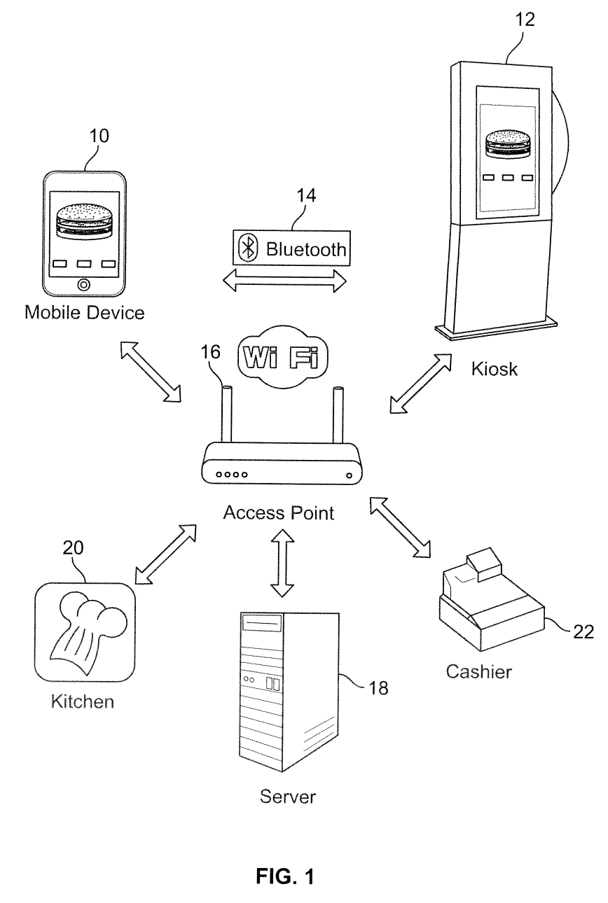

FIG. 1 depicts a flow diagram of the system architecture of an illustrated embodiment of the mobile-based voiceless drive-through ordering system and method of the present invention. The system primarily comprises a mobile device 10, a drive-through kiosk 12 with a Bluetooth 14 wireless personal area network, a WiFi access point 16 at a restaurant, a back-end data server 18 at a restaurant, the kitchen 20 at a restaurant and the cashier 22 at a restaurant.

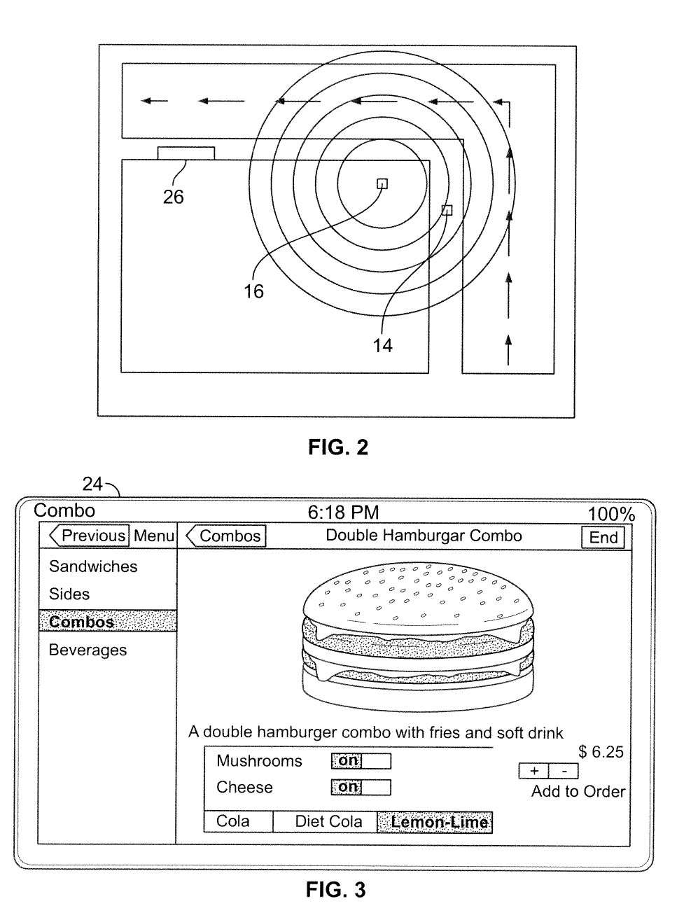

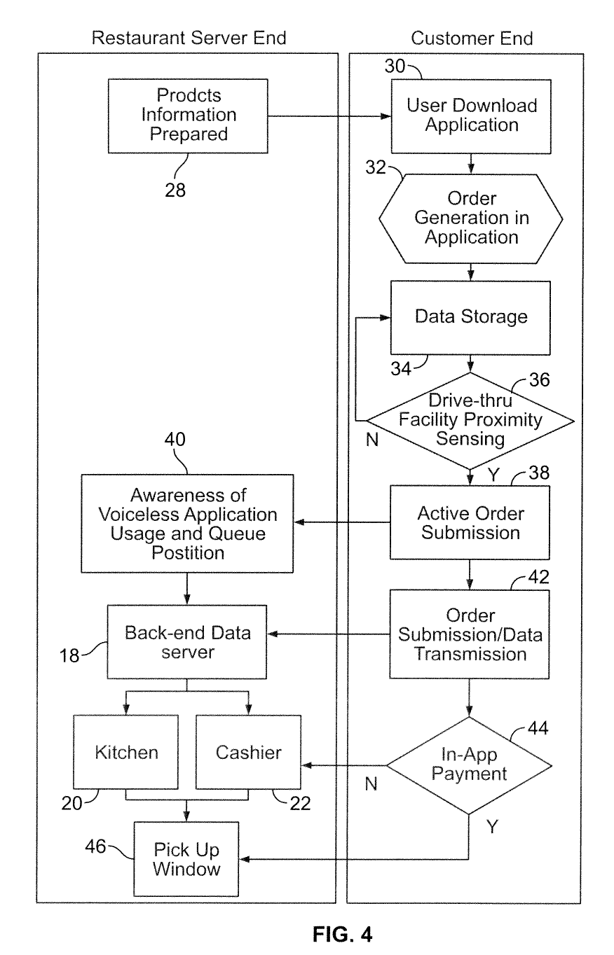

FIG. 2 depicts a system implementation in a typical one-lane drive through facility. A user downloads the mobile-based voiceless drive-through ordering system and method onto their mobile device 10. The user obtains the detailed product's information through the user interface 24, example shown in FIG. 3, of the application and can make the order at the restaurant's drive-through or at any place, such as home or office, and then saves it in the mobile device. As the user approaches the Bluetooth transmitter 14 in the drive-through kiosk 12, the mobile device 10 detects the signal from the proximity sensor, the Bluetooth transmitter 14, and the mobile-based application synchronizes and submits the user's order to the back-end data server 18 via the restaurant's WiFi transceiver 16. The restaurant's WiFi transceiver 16 access point allows the order and payment information generated by the user and the mobile-based application to be transmitted through the wireless network to the back-end data server 18 of the restaurant. The back-end data server 18 receives the order and payment information from the user's mobile-based application and provides data storage and database services for the restaurant cashier 22 processing and restaurant kitchen 20 processing. The user may then pick up his order at the drive-through window 26.

FIG. 4 depicts a flow diagram of a first embodiment of the mobile-based voiceless drive-through ordering system and method. The restaurant prepares its own individualized menu product information 28. Once within range of the restaurant's WiFi transceiver 16, the user opens the mobile-based application 30 on their mobile device 10 and, through the user interface 24, generates a menu product order 32. The user could also generate a menu product order 32 from a remote location, such as home or office. The order information and payment data is stored 34 in the mobile device 10 until the mobile device 10 detects the signal from the Bluetooth transmitter 14 proximity sensor. As the user approaches the drive-through kiosk 12, the mobile device 10 detects the signal 36 from the Bluetooth transmitter 14. The active order submission 38 is detected by the WiFi transceiver 16, which is aware of the mobile-based voiceless application usage and queue position 40. The queue position 40 and the order information and payment data are transmitted 42 to the back-end data server 18. The back-end data server 18 then transmits the order information to the kitchen 20 and the cashier 22. If the user did not pay in the mobile-based application 44, the user must pay the cashier 22. Otherwise, if the user did pay in the mobile-based application 44, the user can go straight to the pick-up window 46 and receive the order.

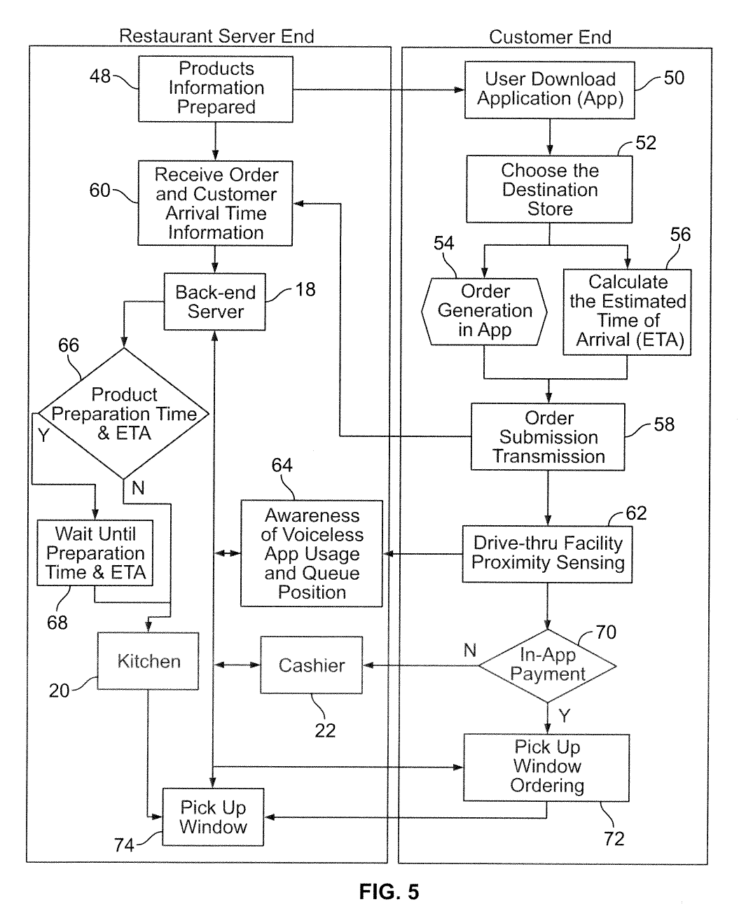

FIG. 5 depicts a flow diagram of a second embodiment of the mobile-based voiceless drive-through ordering system and method. The restaurant prepares its own individualized menu product information 48. The user opens the mobile-based application 50 on their mobile device 10 and, through the user interface 24, chooses a destination store 52. The mobile-based application generates a menu product order 54 from the user's choices and calculates the user's estimated time of arrival 56. The order information and payment data, along with the user's estimated time of arrival, is transmitted to the restaurant 58. The restaurant receives the order and payment information and the user's estimated time of arrival 60 and stores it in the back-end data server 18. As the user approaches the drive-through kiosk 12, the mobile device 10 detects the signal 62 from the Bluetooth transmitter 14 proximity sensor and the restaurant's WiFi transceiver 16 becomes aware of the mobile-based voiceless application usage and queue position 64. The back-end data server 18 continually compares the product preparation time to the user's estimated time of arrival 66 and when the product preparation time equals the user's estimated time of arrival, the back-end data server 18 transmits the order information 68 to the kitchen 20. The back-end data server 18 sends payment information to the cashier 22 and if the user did not pay in the mobile-based application 70, the user must pay the cashier 22. Otherwise, if the user did pay in the mobile-based application 70, the user is directed 72 to the pick-up window 74 to receive the order.

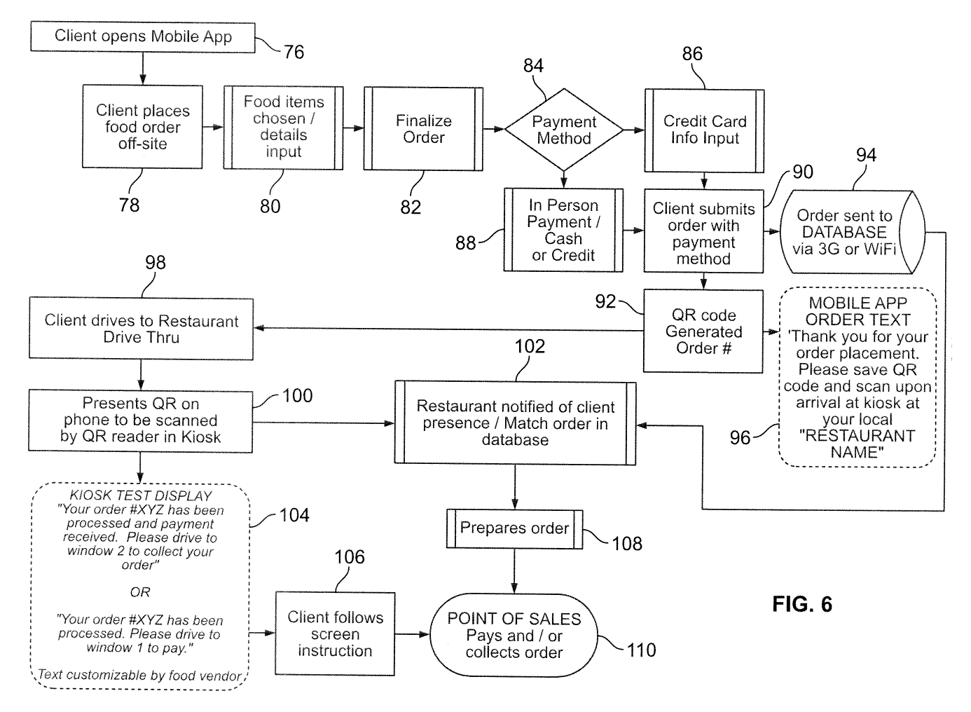

FIG. 6 depicts a flow diagram of a third embodiment of the mobile-based voiceless drive-through ordering system and method. The user opens the mobile-based application 76 on their mobile device 10 and, through the user interface 24, places an order 78, regardless of the user's location. The user inputs the food items and details 80 and finalizes the order 82. The user must then choose a payment method 84. If the user is using a credit card as the form of payment, the user can input the credit card information 86 into the mobile-based application. Otherwise, the user can prefer to pay in person 88. The user then submits the order and payment information 90. A QR code is generated with the order number 92 and the order and payment information is sent 94 to the back-end data server 18 via the mobile device's 10 3G service or WiFi. The mobile-based application order text displays “Thank you for your order placement. Please save QR code and scan upon arrival at kiosk at your local 'Restaurant Name” 96, or some other confirmation and instructions regarding the particular restaurant. The user then drives to the restaurant's drive-through 98 and as the user approaches the drive-through kiosk 12, the mobile device 10 detects the signal from the Bluetooth transmitter 14 proximity sensor. The user presents the QR code on the user's mobile device 10 to be scanned by the QR reader 100 in the drive-through kiosk 12 and the kiosk 12 text displays “Your order ### has been processed and payment received. Please drive to window 2 to collect your order,” “Your order ### has been processed. Please drive to window 1 to pay,” 104 or some other confirmation and instructions regarding the user's order number. The restaurant is notified of the user's presence and matches the user to the order 102 in the back-end data server 18. The user follows the drive-through kiosk 12 instructions 106 and the kitchen 20 prepares the order 108. The user drives to the pick-up window and pays and/or collects the order 110.

The foregoing description of illustrated embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for mobile based voiceless drive-through ordering, the method comprising:
a. displaying menu product information from a server;
b. generating a product order from the menu product information;
c. storing the product order;
d. sensing the proximity of a drive-through facility of a destination;
e. detecting a queue position and transmitting the queue position to a back-end data server;
f. transmitting the product order and submitting the product order to the back-end data server;
g. transmitting the product order to a kitchen and a cashier from the back-end data server;
h. transmitting payment information to the cashier; and
i. delivering the product order.

2. The method of claim 1, wherein sensing the proximity of a drive-through facility further comprises transmitting a Bluetooth signal and detecting the Bluetooth signal.

3. The method of claim 1, wherein the destination further comprises WiFi to detect order submission and queue position.

4. A mobile device for mobile based voiceless drive-through ordering, the mobile device communicatively coupled to a server, the mobile device comprising:
a. a downloadable drive-through ordering mobile application capable of presenting menu product information from the server via the interface;
b. the downloadable drive-through ordering mobile application capable of receiving a product order via the interface;
c. the downloadable drive-through ordering mobile application capable of storing the product order;
d. the downloadable drive-through mobile application capable of sensing the proximity of a drive-through facility;
e. the downloadable drive-through mobile application capable of transmitting and submitting the product order to a back-end data server; and
f. the downloadable drive-through mobile application capable of transmitting payment information.

5. A system for mobile-based voiceless drive-through ordering, the system comprising:
a. an interface adapted to be used on different mobile device platforms on the mobile device to exchange information between the mobile device and a server;
b. a short range communication system selectively connectable to a wireless personal area network;
c. a flexible data communication system selectively connectable to a wireless local area network; and
d. a back end data server receiving and processing the information from the interface.

6. A method for mobile based voiceless drive-through ordering, the method comprising:
a. displaying menu product information from a server;
b. choosing a destination;
c. generating a product order from the menu product information;
d. inputting payment information;
e. calculating an estimated time of arrival at the destination;
f. transmitting the product order to a back-end data server;
g. receiving the product order and the estimated time of arrival;
h. sensing the proximity of a drive-through facility at the destination;
i. detecting a queue position and transmitting the queue position to a back-end data server;
j. transmitting the product order to a kitchen from the back-end data server at the estimated time of arrival;
k. transmitting payment information to a cashier; and
l. delivering the product order.

7. The method of claim 6, wherein sensing the proximity of a drive-through facility further comprises transmitting a Bluetooth signal and detecting the Bluetooth signal.

8. The method of claim 6, wherein the destination further comprises WiFi to detect order submission and queue position.

9. A method for mobile based voiceless drive-through ordering, the method comprising:
a. displaying menu product information from a server;
b. generating a product order from the menu product information;
c. inputting payment information;
d. transmitting the product order and payment information to a back-end data server;
e. generating a QR code with the product order;
f. displaying a confirmation text on the mobile device;
g. presenting QR code to be scanned at a drive-through facility;
h. displaying a confirmation text on the drive-through facility;
i. notifying a destination store of customer's arrival;
j. matching QR code with order in the back-end data server;
k. transmitting the product order to a kitchen from the back-end data server;
l. transmitting payment information to a cashier; and
m. delivering the product order.

10. The method of claim 9, wherein sensing the proximity of a drive-through facility further comprises transmitting a Bluetooth signal and detecting the Bluetooth signal.

11. The method of claim 9, wherein the destination further comprises WiFi to detect order submission and queue position.

12. The method of claim 1, wherein the payment information comprises one of credit card information, debit card information and cash.

13. The method of claim 8, wherein the payment information comprises one of credit card information, debit card information and cash.

14. The method of claim 9, wherein the payment information comprises one of credit card information, debit card information and cash.
